(19) United States
(12) Patent Application Publication
(10) Pub. No.: US 2025/0000061 A1
(43) Pub. Date: Jan. 2, 2025

(54) ANTI-PULLING ANIMAL COLLAR

(71) Applicant: Radio Systems Corporation, Knoxville, TN (US)

(72) Inventor: Christopher Spater, Burlington, VT (US)

(21) Appl. No.: 18/883,012

(22) Filed: Sep. 12, 2024

Related U.S. Application Data
(63) Continuation of application No. 17/481,717, filed on Sep. 22, 2021.
(60) Provisional application No. 63/081,734, filed on Sep. 22, 2020.

(51) Int. Cl. A01K 27/00

(52) U.S. Cl. CPC A01K 27/001

(57) ABSTRACT

An anti-pulling animal collar includes a base collar having a front strap and a back strap having a centrally mounted leash D-ring. The front strap includes a first row of soft spikes, a second row of soft spikes, and a trachea portion positioned between the first row and second row of spikes. The trachea portion has two oppositely disposed soft spikes and a bridge extending between the two soft spikes. The trachea portion has a longitudinally extending strap channel through which extends the front strap. Each soft spike also has a strap channel through which extends the front strap. The soft spikes have a base and a pyramid shaped top portion that extends from the base in a direction towards the animal.

### CROSS REFERENCE TO RELATED APPLICATIONS

This application claims the benefit of U.S. Patent Application No. 63/081,734, filed Sep. 22, 2020, which is incorporated herein by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### Field of the Invention

The present inventive concept relates to the field of dog collars and harnesses. More particularly, the invention relates to a dog collar or harness that modifies a dog's behavior to prevent the dog from pulling on a leash coupled to the collar while also protecting the trachea of the dog from damage during training.

### Background of the Invention

Oftentimes, people own dogs that have a bad habit of pulling away from the owner as the owner walks the dog. Some people simply do not have the time, knowledge or ability to properly train a dog to prevent this unwanted behavior. Thus, this unwanted behavior may cause a dog owner to avoid walking the dog.

One device which has been developed to prevent a dog from pulling on the leash is a harness with a leash coupler mounted upon the dog's chest area. As the dog pulls upon the harness, the pulling on the leash causes the dog to turn from its intended direction due to the offset pulling upon the harness. As the dog cannot move towards its desired location by pulling on the leash, it is supposed to learn that the pulling prevents such from occurring. However, some dogs simply do not learn to avoid this behavior and continue to pull upon the leash.

Another device to prevent pulling is the choke collar. These collars are designed to constrict upon the dog's neck when the leash is pulled. These collars can cause great discomfort and may cause harm to the dog's trachea. A modification of the choke collar is the pinch collar that includes prongs that are forced against the skin of the dog when the collar is constricted. These prongs may cause even greater discomfort or harm to the dog neck, and especially the trachea.

Accordingly, a need exists for a device that allows the free movement of a dog while training or modifying the dog's behavior so that the dog does not pull upon the leash. It is to the provision of such therefore that the present invention is primarily directed.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a perspective view of an anti-pulling animal collar embodying principles of the invention in a preferred form.

FIG. 2A is a top view of a portion of the anti-pulling animal collar of FIG. 1.

FIG. 2B is a front view of a portion of the base collar of the anti-pulling animal collar of FIG. 1.

FIG. 3 is an end view of a soft spike of the anti-pulling animal collar of FIG. 1.

FIG. 4 is a top view of a soft spike of the anti-pulling animal collar of FIG. 1.

FIG. 5 is a bottom view of a soft spike of the anti-pulling animal collar of FIG. 1.

FIG. 6 is an end view of a trachea spacer of the anti-pulling animal collar of FIG. 1.

FIG. 7 is a top view of a trachea spacer of the anti-pulling animal collar of FIG. 1.

FIG. 8 is a bottom view of a trachea spacer of the anti-pulling animal collar of FIG. 1.

FIG. 9 is a front view of a trachea spacer of the anti-pulling animal collar of FIG. 1.

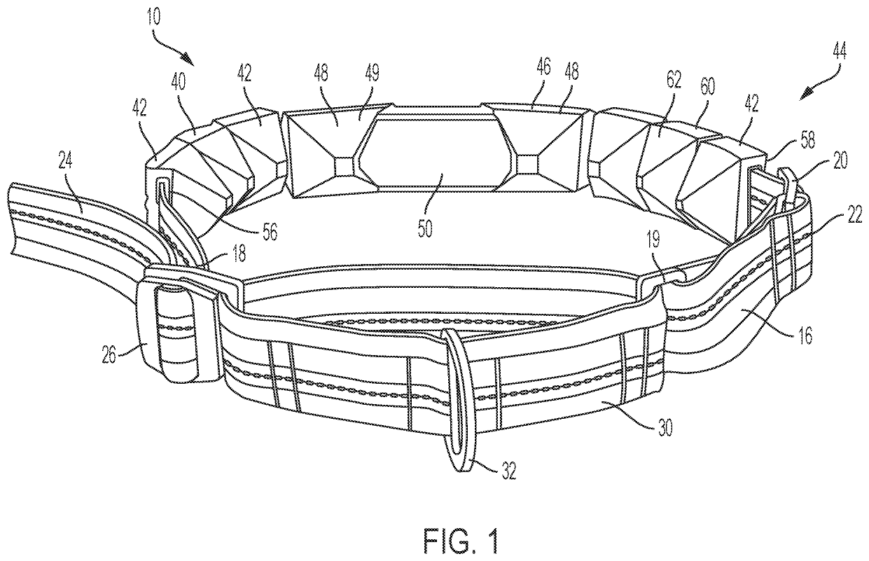

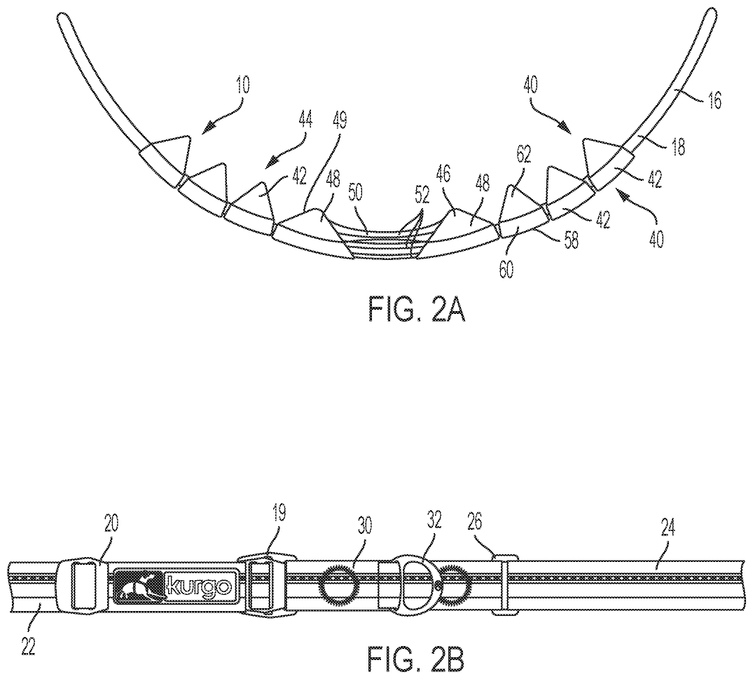

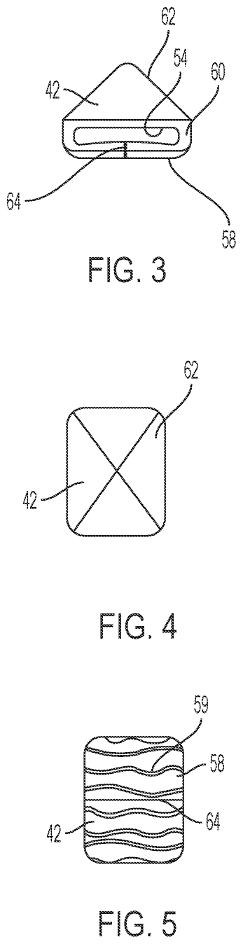

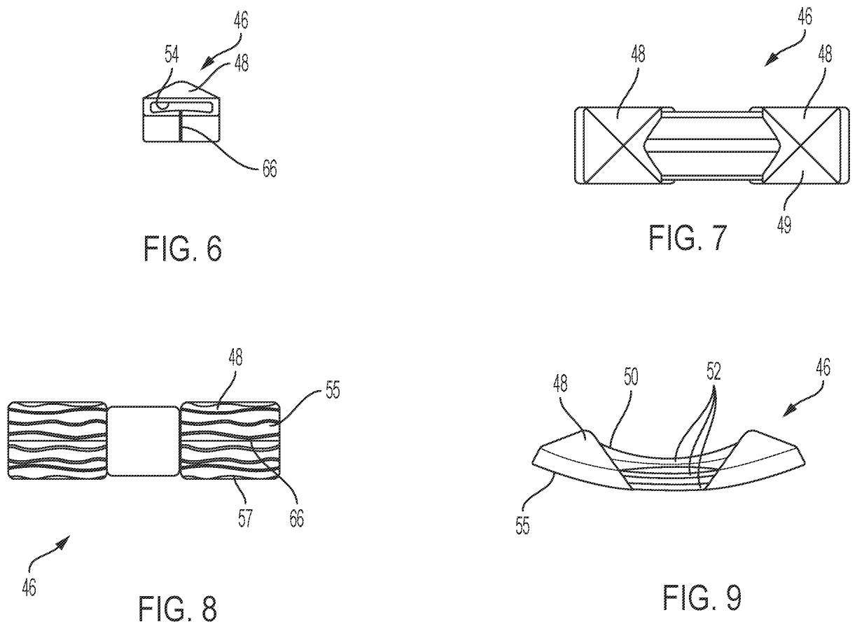

### DETAILED DESCRIPTION

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

With reference next to the drawings, there is a shown a dog training device in the form of an anti-pulling animal collar 10 in a preferred form of the present invention. The anti-pulling animal collar 10 is shown in the form of an animal collar, however, it may also be in the form of a harness or incorporated as a portion of a harness, configured to be worn by a dog in conventional fashion.

The anti-pulling animal collar 10 includes a generally conventional strap, base or base collar 16 configured to fit around the neck of a dog. The base collar 16 has a front strap 18 having a first end 22 which is double upon itself about a strap connector 19 and coupled to an adjustable buckle 20 to adjust the length of the base collar 16. The front strap 18 also has a second end 24 which is coupled to a buckle 26 to allow further adjustment of the length of the base collar 16. The base collar 16 also has a looped back strap 30 which is coupled to and extends between strap connector 19 and buckle 26. The back strap 30 includes a centrally mounted D-ring 32 that allows for the coupling of a leash to the anti-pulling animal collar 10.

The front strap 18 and back strap 30 of the base collar 16 are made of a flexible material, such as a woven strap, leather or plastic material. The length of the front strap 18 may be adjusted in conventional fashion through the changing of the length of the folded over portion of the front strap 18 passing through an adjustment buckle 20. The base collar 16 should fit snuggly about the neck of the dog to prevent the pet anti-pulling animal collar 10 from separating from the dog.

The front strap 18 includes a first or left row 40 or series of three inwardly facing, resilient or soft prongs, projections, or spikes 42, a second or right row 44 or series of soft prongs, projections, or spikes 42, and a middle or trachea portion 46 positioned between the first row 40 and second row 44. The trachea portion 46 is slightly curved with two oppositely disposed or spaced apart resilient or soft spikes 48 and a bridge 50 extending between the two soft spikes 48. The soft spikes 48 have a pyramid shaped top portion or surface 49 extending in an inward direction towards the animal wearing the anti-pull animal collar 10 although the top surface may be any configuration which preferably forms a somewhat rounded point, such as a conical shape. The bridge 50 includes three spans 52. The trachea portion 46 has a longitudinally extending strap channel 54 through which extends the front strap 18. The trachea portion 46 also has a bottom surface 55 with texture ridges 57 to provide traction is inverted against the fur of the animal. The trachea portion 46 has a slit or cut 66 extending completely through the outermost span 52 between the bottom surface 55 and the strap channel 54 that in combination with the resilient nature of the trachea portion material allows the restricted passage of the base collar 16 through the slit 66 if it is desired to remove the trachea portion 46 from the base collar 16.

Each soft spike 42 has a strap channel 56 through which extends the front strap 18. The connection between the strap channels 54 and 56 and the front strap 18 are such that the position of the soft spikes 42 and trachea portion 46 are resistively maintained in place relative to the front strap 18, but may be slid along or repositionable along the front strap with manual force.

Each soft spike 42 has a generally rectangular shaped base 60 through which extends the strap channel 56. The base 60 has a bottom surface 58 having textured ridges 59 to provide traction is inverted against the fur of the animal. A pyramid shaped top portion or surface 62 extends from the base 60 in a direction towards the animal, i.e., extends inwardly with reference to the closed loop anti-pulling animal collar 10, although again the shape may be any that provides a somewhat rounded point. The soft spikes 42 and trachea portion 46 are made of a semi-rigid material, such as thermoplastic elastomer, plastic, rubber, or the like, so that the pointed shape may be slightly deformed with pressure so as to cause discomfort without causing harm to the animal under pressured contact. The soft spikes 42 have a slit or cut 64 extending completely through the base 60 between the bottom surface 58 and the strap channel 56 that in combination with the resilient nature of the soft spike material allows the restricted passage of the base collar 16 through the slit 64 if it is desired to remove a soft spike 42 from the base collar 16 or add additional soft spikes 42.

In use, the pet anti-pulling animal collar 10 is positioned upon a dog with the back strap 30 positioned across the back of a dog's neck so that the front strap 18 is positioned across the front of the dog's neck. The length of the front strap 18 is adjusted through the positioning of the front strap first end 22 about buckle 20 and the front strap second end 24 through buckle 26, so that the anti-puling collar 10 fits snugly around the dog's neck.

Once the anti-pulling animal collar 10 is properly fitted, a leash may be coupled to the anti-pulling animal collar 10 through attachment of the leash to the collar D-ring 32, should the dog owner wish to walk the dog. The dog may then be walked and controlled through the combination of the leash and anti-pulling animal collar 10.

Should the dog owner wish to train the dog not to pull upon the leash, the owner simply allows the dog's pulling action to apply pressure from the leash to the D-ring 32. The pressure upon the D-ring 32 causes the front strap 18 to be pulled toward the dog's neck through the pulling of the back strap 30 coupled to the D-ring 32. This action causes the soft spikes 42 and 48 to apply a concentrated pressure of the pointed top surface 62 to the dog's neck resulting in discomfort to the dog, which is intended to teach the dog that the discomfort will last until it stops pulling against the leash.

The bridge 50 of the trachea portion 46 is intended to be positioned over the trachea of the dog's throat. The bridge 50 provides a space that is absent of soft spikes so that the soft spikes do not press against or harm the dog's trachea.

It should be understood that the anti-pulling animal collar 10 may be configured with any number of soft spikes 42, depending upon the size or circumference of the dog's neck. Also, it should be understood that the anti-pulling animal collar 10 may be configured with only the trachea portion 46 and without the need to the additional soft spikes 42. Likewise, the soft spikes 42 may be used without the trachea portion 46 with some dogs. The trachea portion 46 may also be configured as only a bridge 50 so as to act as a spacer without its additional soft spikes 48.

It should be understood that the trachea portion 46 provides an area that minimizes or disperses the force being placed upon the dog's trachea area when the leash is pulled, thereby protecting the trachea area from damage.

The soft spikes 42 and trachea portion 46 may be positioned in a reversed orientation upon the base collar 16 so that they face outwardly from the animal when the animal is not being trained. Hence, the anti-pulling animal collar 10 may still include these components if the need arises to reverse the direction for training purposes at a later time.

Also, it should be understood that the anti-pulling animal collar 10 may be of any configuration or in the form of a neck collar or dog harness as a substitute to that described as the preferred embodiment.

An anti-pulling animal collar is described herein comprising under an embodiment a base collar, and a flexible trachea portion coupled to the base collar, the flexible trachea portion having two spaced apart flexible prongs and a flexible bridge extending between the two spaced apart flexible prongs.

The flexible trachea portion of an embodiment has a base with a strap channel therethrough configured to receive the base collar.

The base of the flexible trachea portion of an embodiment has a slit extending from a bottom surface of the flexible trachea portion to the strap channel, whereby the base collar may be forced through the slit into the strap channel.

The bottom surface of the flexible trachea portion has a textured surface, under an embodiment.

A plurality of additional prongs coupled to the base collar, under an embodiment.

Each additional prong of the plurality of additional prongs has a base with a strap channel therethrough configured to receive the base collar, under an embodiment.

The base of each additional prong of an embodiment has a slit extending from a bottom surface of the additional prong to the strap channel of the additional prong, whereby the base collar may be forced through the slit of the additional prong into the strap channel of the additional prong.

The bottom surface of each additional prong of an embodiment has a textured surface.

An anti-pulling animal collar of an embodiment is described herein comprising under an embodiment a base collar, and a plurality of inwardly facing resilient prongs coupled to the base collar, the resilient prongs being repositionable along the base collar.

Each resilient prong of the plurality of inwardly facing resilient prongs has a base with a strap channel therethrough configured to receive the base collar, under an embodiment.

The base of each prong of an embodiment has a slit extending from a bottom surface of the base to the strap channel of the resilient prong, whereby the base collar may be forced through the slit of the resilient prong into the strap channel of the resilient prong.

The anti-pulling animal of an embodiment comprises a resilient trachea portion coupled to the base collar, the resilient trachea portion having a flexible bridge extending between the two oppositely disposed resilient trachea prongs.

The trachea portion of an embodiment also includes two oppositely disposed resilient trachea prongs, wherein the flexible bridge is positioned between the two trachea prongs.

The resilient trachea portion of an embodiment has a base with a strap channel therethrough configured to receive the base collar.

The base of the resilient trachea portion of an embodiment has a slit extending from a bottom surface of the resilient trachea portion to the strap channel of the resilient trachea portion, whereby the base collar may be forced through the slit into the strap channel of the resilient trachea portion.

The bottom surface of the resilient trachea portion has a textured surface, under an embodiment.

An anti-pulling animal collar is described herein comprising under an embodiment a flexible strap, a resilient trachea portion coupled to the strap, the resilient trachea portion having a central portion, a first resilient projection extending from a first end of the central portion, and a second resilient projection extending from a second end of the central portion, a third resilient projection positioned adjacent the first resilient projection oppositely disposed from the central portion, and a fourth resilient projection positioned adjacent the second resilient projection oppositely disposed from the central portion.

The trachea portion of an embodiment has a base with a strap channel therethrough configured to receive the strap.

The base of the trachea portion has a slit extending from a bottom surface of the trachea portion to the strap channel, whereby the strap may be forced through the slit into the strap channel, under an embodiment.

The bottom surface of the trachea portion has a textured surface, under an embodiment.

The third resilient projection has a base with a strap channel therethrough configured to receive the strap, under an embodiment.

The third resilient projection has a slit extending from a bottom surface of the third resilient projection to the strap channel of the third resilient projection, under an embodiment.

It will be appreciated that the embodiments described herein are susceptible to modification, variation and change without departing from the spirit thereof.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. An anti-pulling animal collar, comprising:
a base collar including a flexible strap; and
a plurality of resilient rectangular, pyramid-shaped prongs coupled to the base collar, each prong of the plurality of prongs being repositionable along the base collar, and each prong being disconnected from all remaining prongs within the plurality of prongs such that each prong is movable relative to the base collar and the remaining prongs.

22. The anti-pulling animal collar of claim 21, wherein at least one prong of the plurality of prongs includes a base with a strap channel therethrough configured to receive the base collar.

23. The anti-pulling animal collar of claim 22, wherein at least one prong of the plurality of prongs includes a slit extending from a bottom surface to the strap channel such that the base collar may be forced through the slit of the at least one prong.

24. The anti-pulling animal collar of claim 22, wherein:
each prong of the plurality of prongs extends in a prong direction from the base to a pointed top surface; and
the strap channel of each prong extends perpendicular to the prong direction.

25. The anti-pulling animal collar of claim 24, the base collar being configurable in a closed loop configuration, wherein the base collar forms a continuous loop;
each prong being independently repositionable between an inward-facing direction and an outward-facing direction while the base collar is in the closed loop configuration, wherein:
when in the inward-facing direction, the pointed top surface is oriented toward a center of the closed loop configuration, and
when in the outward-facing direction, the pointed top surface is oriented away from the center of the closed loop configuration.

26. The anti-pulling animal collar of claim 21, wherein a bottom surface of at least one prong includes a textured surface.

27. The anti-pulling animal collar of claim 21, wherein:
the base collar is configurable in a closed loop configuration wherein the base collar forms a continuous loop; and
each prong is configured to be coupled to and decoupled from the base collar while the base collar is configured in the closed loop configuration.

28. The anti-pulling animal collar of claim 21, wherein each prong of the plurality of prongs includes a top surface forming a rounded point.

29. An anti-pulling animal collar, comprising:
a flexible strap; and
a plurality of resilient rectangular pyramid-shaped prongs couplable to the flexible strap, each prong of the plurality of prongs configured to be coupled to the flexible strap independent of all other prongs within the plurality of prongs such that each prong is translatable along the flexible strap independent of the other prongs.

30. The anti-pulling animal collar of claim 29, wherein:
at least one prong of the plurality of prongs includes a base with a strap channel therethrough configured to receive the flexible strap.

31. The anti-pulling animal collar of claim 30, wherein:
at least one prong of the plurality of prongs includes a slit extending from a bottom surface to the strap channel such that the flexible strap may be forced through the slit of the at least one prong.

32. The anti-pulling animal collar of claim 30, wherein:
each prong of the plurality of prongs extends in a prong direction from the base to a pointed top surface; and
the strap channel of each prong extends perpendicular to the prong direction.

33. The anti-pulling animal collar of claim 32, the flexible strap being configurable in a closed loop configuration wherein the flexible strap forms a continuous loop;
each prong being independently repositionable between an inward-facing direction and an outward-facing direction while the flexible strap is in the closed loop configuration, wherein:
when in the inward-facing direction, the pointed top surface is oriented toward a center of the closed loop configuration, and
when in the outward-facing direction, the pointed top surface is oriented away from the center of the closed loop configuration.

34. The anti-pulling animal collar of claim 29, wherein a bottom surface of at least one prong of the plurality of prongs includes a textured surface.

35. The anti-pulling animal collar of claim 29, wherein:
the flexible strap is configurable in a closed loop configuration wherein the flexible strap forms a continuous loop; and
each prong of the plurality of prongs is configured to be coupled to and decoupled from the flexible strap while the flexible strap is configured in the closed loop configuration.

36. The anti-pulling collar of claim 29, wherein each prong of the plurality of prongs includes a top surface forming a rounded point.

37. A prong for an anti-pulling animal collar, the prong comprising:
a resilient rectangular base;
a resilient pyramid-shaped portion extending away from the base in a prong direction;
a strap channel defined through the base and extending perpendicular to the prong direction, the strap channel configured to receive an animal collar therethrough.

38. The prong of claim 37, further comprising a slit extending from a bottom surface of the base to the strap channel such that the animal collar may be forced through the slit.

39. The prong of claim 37, wherein a bottom surface of the base includes a textured surface.

40. The prong of claim 37, further comprising a top surface forming a rounded point.
